(19) United States
(12) Patent Application Publication
(10) Pub. No.: US 2015/0091495 A1
(43) Pub. Date: Apr. 2, 2015

(54) ELECTRONIC DEVICE HAVING WIRELESS LASER CHARGING

(71) Applicants: Rashed MAHAMEED, Beaverton, OR (US); Mohamed A. ABDELMONEUM, Portland, OR (US); Jason KU, San Mateo, CA (US)

(72) Inventors: Rashed MAHAMEED, Beaverton, OR (US); Mohamed A. ABDELMONEUM, Portland, OR (US); Jason KU, San Mateo, CA (US)

(21) Appl. No.: 14/040,255

(22) Filed: Sep. 27, 2013

(51) Int. Cl. H02J 7/35; H02J 7/00

(52) U.S. Cl. CPC H02J 7/355; H02J 7/0068; H02J 7/0045
USPC 320/101

(57) ABSTRACT

An electronic device may include a display, and a laser reception device to receive a laser beam and to provide power based on the received laser beam.

### BACKGROUND

1. Field

Embodiments may relate to an electronic device having a wireless laser reception device and/or laser charging device.

2. Background

Electronic devices may require a power source. A battery is an example of a primary power source. An electronic device may also physically attach to (or include) an alternate current (AC) charger or adapter. This may provide power to the electronic device as a whole, and/or may provide charging of a battery. Charging may also be performed by attaching the electronic device to another power source, such as another battery.

### BRIEF DESCRIPTION OF THE DRAWINGS

Arrangements and embodiments may be described in detail with reference to the following drawings in which like reference numerals refer to like elements and wherein:

FIG. 1 is a side view of an electronic device according to an example embodiment;

FIG. 2 is a view showing wireless laser charging of an electronic device according to an example embodiment;

FIG. 3 is a view showing wireless laser charging of an electronic device according to an example embodiment;

FIG. 4 is a view showing wireless laser charging of two electronic devices according to an example embodiment;

FIG. 5 shows an electronic device according to an example embodiment; and

FIG. 6 shows an electronic device and a transmitter device according to an example embodiment.

### DETAILED DESCRIPTION

In the following detailed description, like numerals and characters may be used to designate identical, corresponding and/or similar components in differing figure drawings. Further, in the detailed description to follow, example sizes/models/values/ranges may be given although embodiments are not limited to the same. Where specific details are set forth in order to describe example embodiments, it should be apparent to one skilled in the art that embodiments may be practiced without these specific details.

An electronic device may any one of a mobile terminal, a mobile device, a mobile computing platform, a mobile platform, a laptop computer, a tablet, an ultra-mobile personal computer, a mobile Internet device, a smartphone, a personal digital assistance, a display device, a television (TV), etc. For ease of discussion and illustration, the following may specifically discuss a laptop computer, although other electronic devices may be used (rather than the laptop computer).

Embodiments may use wireless laser charging for electronic devices (or mobile platforms) such as tablets, smartphones, and laptops. Embodiments may include a transmitter device (or transmitter) and a receiver device (or receiver). The receiver device may be provided on (or at) the electronic device. The transmitting device may transmit up to 25 Watts, for example, within a specific distance range. The distance may be determined by a sensor, for example. As one example, the transmitter device may be provided at a ceiling location or on a table (or in a table).

The receiver device (or receiver) may be provided at the electronic device. As one example, the receiver device may include one or more photovoltaic panels on a portion of the electronic device. The one or more photovoltaic panels may include an array of photovoltaic cells and at least one photo detector. The photo detector may convert optical energy from the photovoltaic cells into power (or electricity).

The receiver device may be a laser reception device (or laser charging device) to receive a laser beam and to provide power based on the received laser beam. The receiver device may be a laser reception device to convert optical energy from a received laser beam into power.

The transmitter device may produce near infrared lasers to eliminate or reduce health risk due to tissue absorption. The transmitter device may also include a lock mechanism to shut down the laser beam (or reduce power of the laser beam) in order to reduce any such risks or other risks. The lock mechanism may be controlled by a controller, for example.

Embodiments may provide wireless laser charging to perform charging of electronic devices (such as on mobile platforms). A laser beam may be generated from (or provided from) a stationary source. The receiving device may include photovoltaic cells and/or at least one photo detector on (or at) the electronic device.

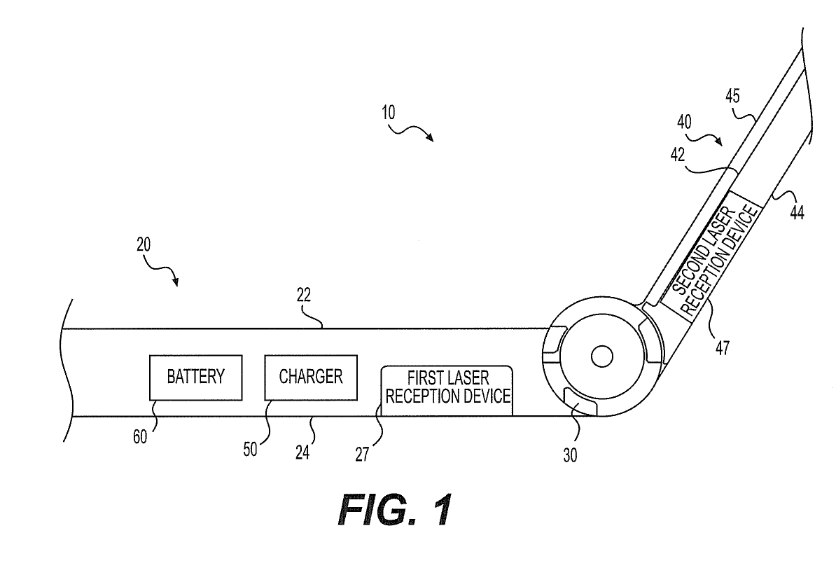

FIG. 1 is a side view of an electronic device according to an example embodiment. Other arrangements and configurations may also be provided. For ease of description, the electronic device may be a computer 10. However, other electronic devices may also be used.

FIG. 1 shows the computer 10 as a notebook computer or a laptop computer, for example. The computer 10 may include a base 20 and a lid 40 that are coupled together by a hinge device 30. The computer 10 may include a body, such as the base 20 and/or the lid 40. FIG. 1 shows the computer 10 in an opened state (or opened position) in which the lid 40 is separated away from the base 20. The computer 10 may also be provided in a closed state (or closed position) when the lid 40 is closed so as to be adjacent to the base 20.

The base 20 of the computer 10 may support various components such as a processor, a touch pad, a memory, a keyboard, a circuit board, a battery, a cooling system, etc. The lid 40 of the computer 10 may support a display 45 (at the body) for a user to view during use of the computer 10.

The base 20 may include a first side 22 (or top side) and a second side 24 (or bottom side). The lid 40 may include a first side 42 and a second side 44. When the computer 10 is in the opened state (such as shown in FIG. 1), the first side 42 of the lid 40 is separated away from the first side 22 of the base 20.

The hinge device 30 may allow the lid 40 to rotate (or move) about a rotational axis that is parallel to a width of the lid 40 (or a width of the base 20). The lid 40 may rotate about the rotational axis of the hinge device 30 between the closed state and the opened state. The hinge device 30 may allow the lid 40 to move relative to the base 20 between the closed state (of the computer 10) and the opened state (of the computer 10).

The base 20 may include a charger 50 (or converter) and a battery 60. The battery 60 may be provided at a battery port. The charger 50 may convert an input voltage into an appropriate direct current (DC) to charge the battery 60 at the battery port. The charger 50 may also provide a voltage (or power) to other components of the computer.

Embodiments may charge electronic devices (such as a laptop computer) in a room, for example, in which a transmitter device may charge the electronic device by having a receiver device provided in a line of sight of the transmitter device.

A receiver device may also be referred to as a detector, a detector device, and/or a laser reception device (or laser charging device).

The base 20 may also include a first laser reception device 27 (or laser charging device). The first laser reception device 27 may be exposed to an exterior of the second side 24 of the base 20, for example. The first laser reception device 27 may be considered to be within skin of the base 20. The first laser reception device 27 may be considered a form factor of the base 20.

The lid 40 may also include a second laser reception device 47 (or second laser charging device). The second laser reception device 47 may be exposed to an exterior of the second side 44 of the lid 40, for example. The second laser reception device 47 may be considered to be within skin of the lid 40. The second laser reception device 47 may be a form factor of the lid 40.

In at least one embodiment, at least one of the first laser reception device 27 or the second laser reception device 47 may be provided at the computer 10. In at least one embodiment, both the first laser reception device 27 and the second laser reception device 47 may be provided at the computer 10.

In at least one embodiment, only one of the first laser reception device 27 or the second laser reception device 47 may be provided at the computer 10.

The first laser reception device 27 may detect (or receive) a laser beam, convert optical energy of the laser beam into electricity (or power), and provide the converted power to charge a component (or element) of the electronic device. The first laser reception device 27 may provide power to the charger 50, for example.

The first laser reception device 27 may receive optical energy from a laser beam. For example, photovoltaic cells (and a pho to detector) of the first laser reception device 27 may convert laser light (or optical energy) to energy (or power). In at least one example, the converted energy may be provided to the battery 60 and/or other components (or elements) of the computer 10.

The second laser reception device 47 may detect (or receive) a laser beam, convert optical energy of the laser beam into electricity (or power), and provide the converted power to charge a component (or element) of the electronic device. The second laser reception device 47 may provide power to a charger, for example.

The second laser reception device 47 may receive optical energy from a laser beam. For example, photovoltaic cells (and a photo detector) of the second laser reception device 47 may convert laser light (or optical energy) to energy (or power). In at least one example, the converted energy may be provided to the battery 60 and/or other components of the computer 10.

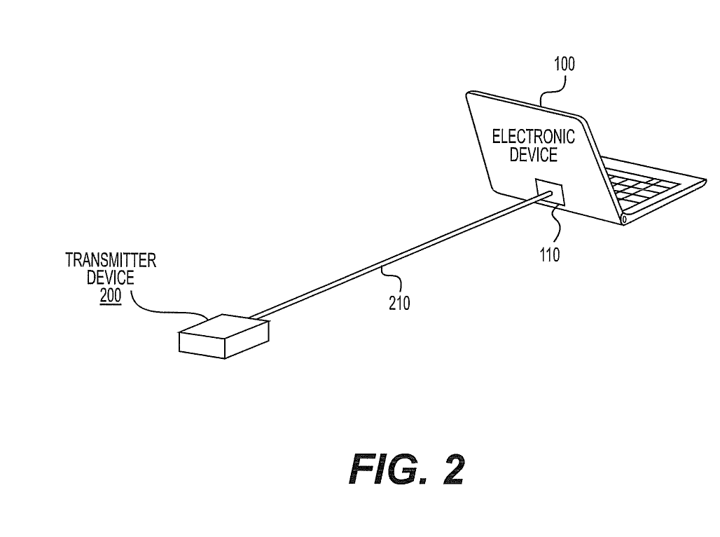

FIG. 2 is a view showing charging of an electronic device according to an example embodiment. Other embodiments and configurations may also be provided. For ease of description, an electronic device may be a laptop.

FIG. 2 shows a laser wireless charging system such as a contactless system where an electronic device (i.e., a mobile platform) is located within a specific distance from a laser transmitter device.

FIG. 2 shows an electronic device 100 that includes at least one laser reception device 110 (or detector). The laser reception device 110 may correspond to the second laser reception device 47 shown in FIG. 1. The laser reception device 110 may be provided on (or at) a part of the electronic device 100 (such as on (or at) a lid of a laptop computer). The laser reception device may be provided at a body of the electronic device.

A laser reception device may also be provided on (or at) another part of the electronic device 100 (such as on a bottom surface of the laptop computer).

FIG. 2 also shows a transmitter device 200. The transmitter device 200 may include a laser transmitter to provide a laser beam 210. The transmitter device 200 may include laser diodes to produce the laser beam 210. The laser transmitter and/or the laser diodes may be part of a laser device.

The electronic device 100 may be aligned such that the laser beam 210 is received at the laser reception device 110 (or detector). The alignment may be provided by a user properly locating the electronic device 100 (relative to the laser beam 210). The electronic device 100 may be provided (or placed) such that the laser reception device 110 (or detector) is provided within a line of sight of the laser beam 210.

The laser reception device 110 may include photo detectors in a photovoltaic array. The photo detectors may use optical energy that is transmitted using the laser beam 210 in order to convert the optical energy into electricity. The converted energy may then be charged to a battery of the electronic device 100 (such as via a battery charger).

The photovoltaic cells of the laser reception device 110 may use the laser beam 210 due to high energy intensity of the laser beam 210.

The transmitter device 200 may include a scattering subsystem, such as optics or mirrors, to generate a wide laser footprint using concave mirrors. A size of the laser spot may be controlled by optics or mirrors of the transmitter device 200 to optimize charging of the photovoltaic cells.

The photovoltaic (PV) cells (or solar cells) may take advantage of a photoelectric effect in order to produce electricity. The photovoltaic cells may convert sunlight to electricity. The individual photovoltaic cells may be electricity-producing devices made of semiconductor materials. In at least one embodiment, the photovoltaic cells may be connected together to form photovoltaic modules.

The photovoltaic modules may be combined and connected to form photovoltaic arrays, for example. The modules of the array make up part of a photovoltaic system (or laser charging system).

When light shines on one of the photovoltaic cells, the light may be reflected, absorbed, or pass right through. The absorbed light may generate electricity. The energy of the absorbed light may be transferred to electrons in atoms of the photovoltaic cell semiconductor material. These electrons may escape from their normal positions in the atoms and become part of the electrical flow, or current, in an electrical circuit. The electrical flow may be to a charger, for example.

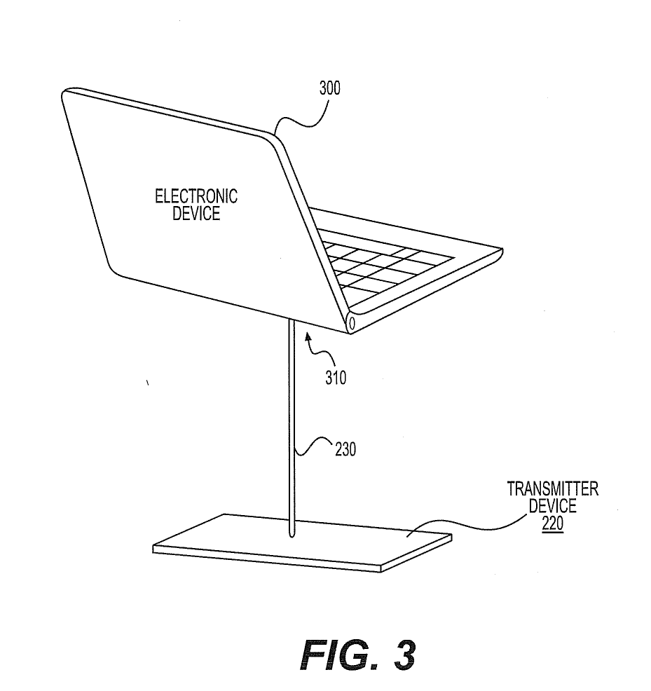

FIG. 3 is a view showing charging of an electronic device according to an example embodiment. Other embodiments and configurations may also be provided. For ease of description, an electronic device may be a laptop computer.

FIG. 3 shows a laser wireless charging system, such as a contact system where an electronic device (such as a mobile platform) can be provided directly on top of a laser transmitter device (or in close proximity of a laser transmitter device). FIG. 3 shows that an electronic device 300 is separated from a laser transmitter. However, in operation, the electronic device 300 may physically contact the laser transmitter (or be close to contacting the laser transmitter).

FIG. 3 shows that the electronic device 300 includes at least one laser reception device 310 (or detector). The laser reception device 310 may correspond to the first laser reception device 27 shown in FIG. 1. The laser reception device 310 may be provided on (or at) a part of the electronic device 300 (such as on or at a lid of a laptop computer).

A laser reception device may also be provided on (or at) another part of the electronic device 300 (such as on a back surface of the lid of the laptop computer).

FIG. 3 also shows a transmitter device 220. The transmitter device 220 may include a laser transmitter to provide a laser beam 230. The transmitter device 220 may include laser diodes to produce the laser beam 230. The laser transmitter and/or laser diodes may be part of a laser device.

The electronic device 300 may be aligned such that the laser beam 230 is received at the laser reception device 310 (or detector). The alignment may be provided by a user properly locating the electronic device 300 (relative to the laser beam 230). The electronic device 300 may be provided (or placed) such that the laser reception device 310 is provided within a line of sight of the laser beam 230.

The laser reception device 310 may include photo detectors in a photovoltaic array. The photo detectors may use optical energy that is transmitted using the laser beam 230 in order to convert the optical energy into electricity. The converted energy may then be charged to a battery of the electronic device 300 (such as via a battery charger.

The photovoltaic cells of the laser reception device 310 may use the laser beam 230 due to high energy intensity of the laser beam 230.

The transmitter device 220 may include a scattering subsystem, such as optics or mirrors, to generate a wide laser footprint using concave mirrors. A size of the laser spot may be controlled by optics or mirrors of the transmitter device 220 to optimize charging of the photovoltaic cells.

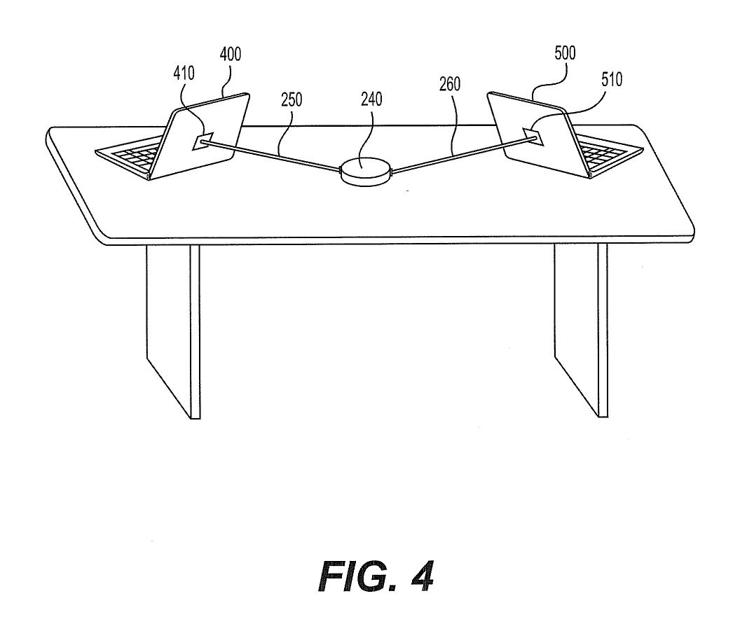

FIG. 4 is a view showing charging of two electronic devices according to an example embodiment. Other embodiments and configurations may also be provided. Other numbers of electronic devices may also be provided. For ease of description, an electronic device may be a laptop computer.

FIG. 4 shows a laser wireless charging system that may simultaneously charge multiple electronic devices. For example, the transmitter device may include multiple laser sources along with scattering optics (or mirrors) arranged in spherical or circular configurations. The transmitter device may be provided on a table or at a room ceiling, for example. The transmitter device may also rotate to scan the room to find electronic devices and lock on them to maintain the line of sight, or different lines of sight (for multiple receivers).

FIG. 4 shows an electronic device 400 that includes at least one laser reception device 410 and another electronic device 500 that includes at least one laser reception device 510.

The laser reception device 410 may correspond to the second laser reception device 47 shown in FIG. 1. The laser reception device 410 may be provided on (or at) a part of the electronic device 400 (such as on a lid of a laptop computer). A laser reception device may also be provided on (or at) another part of the electronic device 400 (such as on or at a bottom surface of the laptop computer).

The laser reception device 510 may correspond to the second laser reception device 27 shown in FIG. 1. The laser reception device 510 may be provided on (or at) a part of the electronic device 500 (such as on a lid of a laptop computer). A laser reception device may also be provided on (or at) another part of the electronic device 500 (such as on or at a bottom surface of the laptop computer).

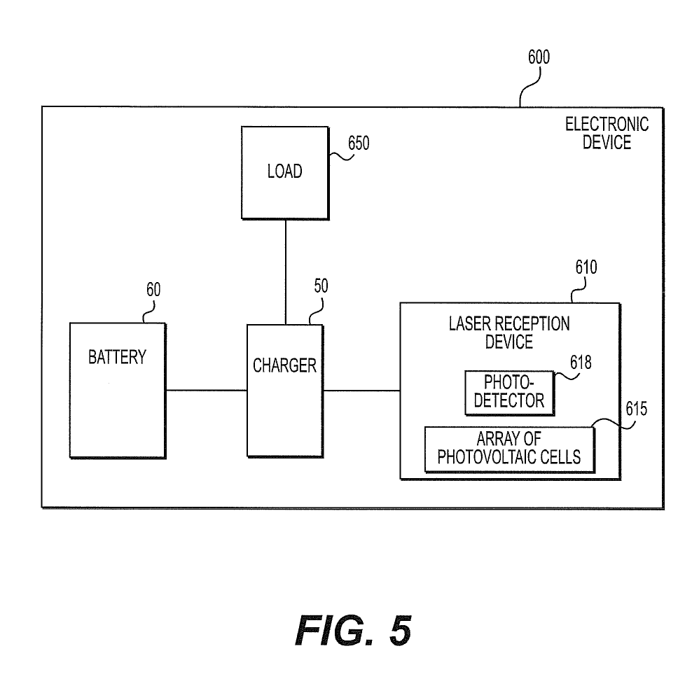

FIG. 5 also shows a transmitter device 240. The transmitter device 240 may include a laser transmitter to provide a first laser beam 250 and a second laser beam 260. Other numbers of laser beams may also be provided by the transmitter device. The transmitter device 230 may include laser diodes to produce the first laser beam 250 and the second laser beam 260. The laser transmitter and/or the laser diodes may be part of a laser device.

The electronic device 400 may be aligned such that the first laser beam 250 is received at the laser reception device 410. The electronic device 500 may be aligned such that the second laser beam 260 is received at the laser reception device 510. The alignment may be provided by a user (or users) properly locating the electronic devices 400, 500 relative to the laser beams 250, 260, respectively.

The electronic device 400 may be provided such that the laser reception device 410 is provided within a line of sight of the first laser beam 250. The electronic device 500 may be provided such that the laser reception device 510 is provided within a line of sight of the second laser beam 260.

The laser reception device 410 may include photo detectors in a photovoltaic array. The photo detectors may use optical energy that is transmitted using the first laser beam 250 to convert the optical energy into electricity. The converted energy may then be charged to a battery of the electronic device 400 (such as via a battery charger). The photovoltaic cells of the laser reception device 410 may use the first laser beam 250 due to high energy intensity of the first laser beam 250.

The laser reception device 510 may include photo detectors in a photovoltaic array. The photo detectors may use optical energy that is transmitted using the second laser beam 260 to convert the optical energy into electricity. The converted energy may then be charged to a battery of the electronic device 500 (such as via a battery charger). The photovoltaic cells of the laser reception device 510 may use the second laser beam 260 due to high energy intensity of the second laser beam 250.

The transmitter device 240 may include a scattering subsystem that generates a wide laser footprint using concave mirrors (or optics). A size of the laser spot may be controlled by optics or mirrors to optimize charging by the photovoltaic cells.

FIG. 5 shows an electronic device according to an example embodiment. Other embodiments and configurations may also be provided. For ease of description, an electronic device may be a laptop computer.

More specifically, FIG. 5 shows an electronic device 600 that may correspond to any of the electronic devices discussed above. The electronic device 600 may include a laser reception device 610, such as the first laser reception device 27 and/or the second laser reception device 47. The laser reception device 610 may include an array of photovoltaic cells 615 and a photo detector 618.

The electronic device 600 may also include the charger 50 (or converter) to receive power from the laser reception device 610. The charger 50 may receive power from other devices, such as an external power source.

The charger 50 may provide the converted power to the battery 60 (in the battery port) and to a load 650. The load 650 may include a display, a processor, a controller, etc.

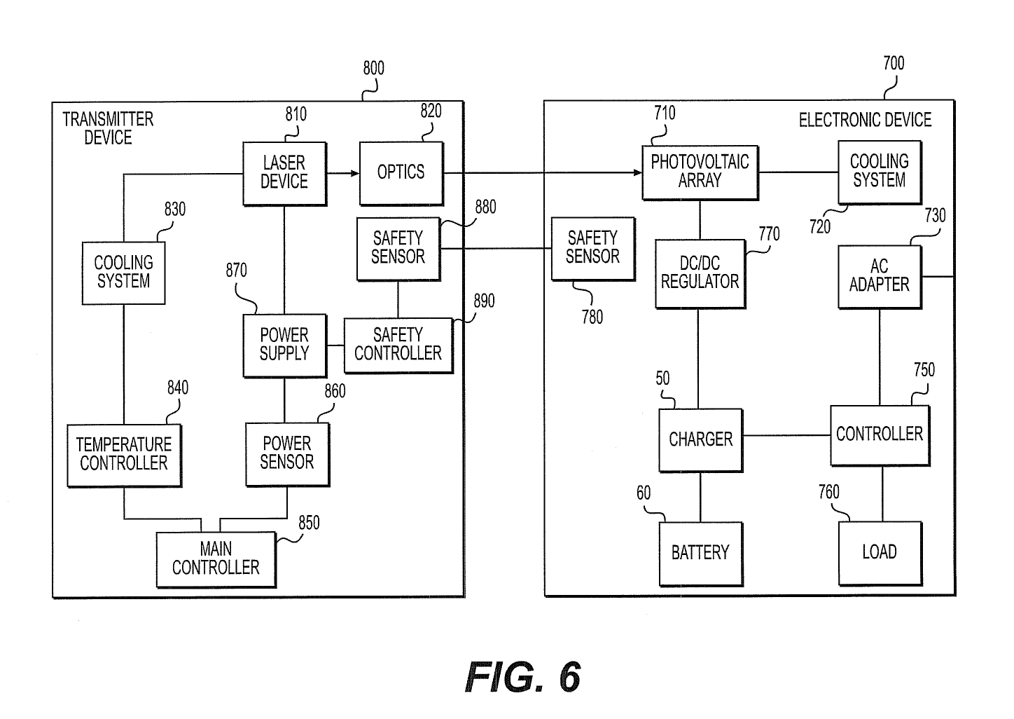

FIG. 6 shows an electronic device and a transmitter device according to an example embodiment. Other embodiments and configurations may also be provided.

More specifically, FIG. 6 shows an electronic device 700 that includes a photovoltaic array 710 and a cooling system 720. The photovoltaic array 710 may include a plurality of photovoltaic cells and a detector to convert optical power into electricity. The photovoltaic array 710 and the detector may be part of a laser reception device. The converted electricity may be provided to a direct current (DC)/DC regulator 770.

The cooling system 720 may be any of a number of devices to cool the photovoltaic array 710. For example, the cooling system 710 may include a fan, a heat sink, etc.

The electronic device 700 may also include an alternate current (AC) adapter 730 to receive AC power from an external source. The electronic device 700 may include a controller 750, the charger 50, the battery 60 and a load 760. The load 760 may be a processor, a display, etc.

The electronic device 700 may also include a safety sensor 780 to determine (or notice) a distance between the sensor 780 and another device, such as a transmitter device. The safety sensor 780 may provide information (such as distance) to a controller or a processor, which may control an operation based on the received information.

FIG. 6 also shows a transmitter device 800 that includes a laser device 810 and optics 820 to provide a laser beam to the electronic device, such as the electronic device 700. The optics 820 may include mirrors to reflect the laser beam provided from the laser device 810.

The transmitter device 800 may include a cooling system 830. The cooling system 830 may be any of a number of devices to cool the laser device 810. For example, the cooling system 830 may include a fan, a heat sink, etc.

The transmitter device 800 may also include a safety sensor 880 to determine (or notice) a distance between the sensor and another device, such as an electronic device. The safety sensor 880 may provide information (such as distance) to a controller (such as a safety controller 890), which may control an operation based on the received information. For example, the safety sensor 880 may be used to turn off (or reduce power) the laser device 810 based on distance between the sensor 880 and an electronic device.

The transmitter device 800 may include other components including a power supply 870, a power sensor 860, a temperature controller 840, a main controller 850 and the safety controller 890. The temperature controller 840 may control the cooling system 830 to cool the laser device 810.

Embodiments may provide a charging configuration having a contactless configuration, where the electronic device (or platform) and the transmitter device are separated from each other. Embodiments may provide a charging configuration having a contact configuration where the electronic device (mobile platform) may be provided on top of a laser transmitter. For example, the laser transmitter may be integrated on a flat pad.

In at least one embodiment, the transmitter device may include logic to turn off (or shut down) the laser beam within <100 m sec., for example, when a barrier object interferes into the laser beam.

The following examples pertain to further embodiments.

Example 1 pertains to an electronic device comprising: a body, a display at a portion of the body, and a laser reception device at the body to receive a laser beam and to provide power based on the received laser beam.

In Example 2, the subject matter of Example 1 can optionally include that the laser reception device to include a plurality of photovoltaic cells.

In Example 3, the subject matter of Example 1 can optionally include a charger to receive the power from the laser reception device and to provide a voltage.

In Example 4, the subject matter of Example 3 can optionally include a battery port to receive a battery.

In Example 5, the subject matter of Example 4 can optionally include that the charger to provide voltage to a battery at the battery port.

In Example 6, the subject matter of Example 5 can optionally include a load, and the charger to provide voltage to the load.

In Example 7, the subject matter of Example 2 can optionally include that the body includes a lid and a base.

In Example 8, the subject matter of Example 7 can optionally include that the plurality of photovoltaic cells are at the lid of the electronic device.

In Example 9, the subject matter of Example 7 can optionally include that the plurality of photovoltaic cells to be at the base of the electronic device.

In Example 10, the subject matter of Example 1 can optionally include that the laser reception device includes at least one photo detector to convert optical energy to power.

Example 11 is an electronic device comprising: a body, a display, and a laser reception device at a surface of the body to convert optical energy power from a received laser beam into power.

In Example 12, the subject matter of Example 11 can optionally include that the laser reception device to include a plurality of photovoltaic cells.

In Example 13, the subject matter of Example 11 can optionally include a charger to receive the power from the laser reception device and to provide a voltage.

In Example 14, the subject matter of Example 13 can optionally include a battery port to receive a battery.

In Example 15, the subject matter of Example 14 can optionally include that the charger to provide voltage to a battery at the battery port.

In Example 16, the subject matter of Example 11 can optionally include a load, and the charger to provide voltage to the load.

In Example 17, the subject matter of Example 12 can optionally include that the body includes a lid and a base.

In Example 18, the subject matter of Example 17 can optionally include that the plurality of photovoltaic cells are at the lid of the electronic device.

In Example 19, the subject matter of Example 17 can optionally include that the plurality of photovoltaic cells are at the base of the electronic device.

In Example 20, the subject matter of Example 11 can optionally include that the laser reception device includes at least one photo detector to convert optical energy to power.

Example 21 is an electronic device to receive wireless laser charging comprising: a body, a display at a portion of the body, means for receiving a laser beam, and means for providing power to components of the electronic device based on the received laser beam.

In Example 22, the subject matter of Example 21 can optionally include that the means for receiving to include a plurality of photovoltaic cells.

In Example 23, the subject matter of Example 21 can optionally include that the means for providing to include a charger to receive the power from the means for receiving and to provide a voltage.

In Example 24, the subject matter of Example 23 can optionally include a battery port to receive a battery.

In Example 25, the subject matter of Example 24 can optionally include that the charger to provide the voltage to a battery at the battery port.

In Example 26, the subject matter of Example 23 can optionally include a load, and the charger to provide voltage to the load.

In Example 27, the subject matter of Example 22 can optionally include that the body includes a lid and a base.

In Example 28, the subject matter of Example 27 can optionally include that the plurality of photovoltaic cells are at the lid of the electronic device.

In Example 29, the subject matter of Example 27 can optionally include that the plurality of photovoltaic cells are at the base of the electronic device.

In Example 30, the subject matter of Example 21 can optionally include that the means for receiving includes at least one photo detector to convert optical energy to power

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
a body;
a display at a portion of the body; and
a laser reception device at the body to receive a laser beam and to provide power based on the received laser beam.

2. The electronic device of claim 1, wherein the laser reception device to include a plurality of photovoltaic cells.

3. The electronic device of claim 1, further comprising:
a charger to receive the power from the laser reception device and to provide a voltage.

4. The electronic device of claim 3, further comprising:
a battery port to receive a battery.

5. The electronic device of claim 4, wherein the charger to provide voltage to a battery at the battery port.

6. The electronic device of claim 5, further comprising a load, and the charger to provide voltage to the load.

7. The electronic device of claim 2, wherein the body includes a lid and a base.

8. The electronic device of claim 7, wherein the plurality of photovoltaic cells are at the lid of the electronic device.

9. The electronic device of claim 7, wherein the plurality of photovoltaic cells are at the base of the electronic device.

10. The electronic device of claim 1, wherein the laser reception device includes at least one photo detector to convert optical energy to power.

11. An electronic device comprising:
a body;
a display; and
a laser reception device at a surface of the body to convert optical energy power from a received laser beam into power.

12. The electronic device of claim 11, wherein the laser reception device to include a plurality of photovoltaic cells.

13. The electronic device of claim 11, further comprising:
a charger to receive the power from the laser reception device and to provide a voltage.

14. The electronic device of claim 13, further comprising:
a battery port to receive a battery.

15. The electronic device of claim 14, wherein the charger to provide voltage to a battery at the battery port.

16. The electronic device of claim 13, further comprising a load, and the charger to provide voltage to the load.

17. The electronic device of claim 12, wherein the body includes a lid and a base.

18. The electronic device of claim 17, wherein the plurality of photovoltaic cells are at the lid of the electronic device.

19. The electronic device of claim 17, wherein the plurality of photovoltaic cells are at the base of the electronic device.

20. The electronic device of claim 11, wherein the laser reception device includes at least one photo detector to convert optical energy to power.
